(19) United States
(12) Patent Application Publication
(10) Pub. No.: US 2014/0025498 A1
(43) Pub. Date: Jan. 23, 2014

(54) METHOD FOR PROVIDING CONTENT

(71) Applicant: Evgeny LYKOV, Metsakyla (FI)

(72) Inventor: Evgeny LYKOV, Metsakyla (FI)

(73) Assignee: AITICO OY, LAHTI (FI)

(21) Appl. No.: 13/551,903

(22) Filed: Jul. 18, 2012

(51) Int. Cl. G06F 9/445; G06Q 30/02; G06F 9/44

(52) U.S. Cl. 705/14.58; 717/177; 717/172; 705/14.69

(57) ABSTRACT

The invention relates to methods of provision of content, more particularly for provision of content for patrons of business premises. Especially, the invention is related to a method for providing content at a premises, including at least the steps of preparing content for a computer device, installing content in a plurality of computer devices, transferring the plurality of computer devices to an operator at the premises, preparing updated content for the leased computer devices, and arranging the updated content to be installed on the leased computer devices.

### FIELD OF THE INVENTION

The invention relates to methods of provision of content, more particularly for provision of content for patrons of business premises. Especially, the invention is related to such a method as specified in the preamble of the independent method claim.

### BACKGROUND OF THE INVENTION

Many business premises, such as cafes, restaurants, hotels, barber shops, pubs and other types of business, provide entertainment for their patrons in the form of newspapers and magazines, and/or radio and/or television. Some premises, such as internet cafes, also offer internet-enabled kiosks for free or billable use by patrons.

### SUMMARY OF THE INVENTION

The invention concerns a method for providing content at a premises.

In an advantageous embodiment of the invention, content such as news, entertainment, sports information and other types of readable, viewable and/or listenable content are provided to patrons of a premises through computer devices, which are available for use by the patrons at the premises.

The computer devices can be supplied by a service provider, which prepares content for the devices, installs the prepared content in the devices, provides the computer devices to the premises, and subsequently maintains the computer devices by preparing updated content and installing the updated content to the devices.

In further advantageous embodiment of the invention, the service provider can license one or more pieces of content for provision on a computer device to the premises. In this way, the service provider can provide a ready-to-use package of content with the computer devices.

The computer devices can for example be rented or leased to a party performing business at the premises. In various embodiments of the invention, the computer devices can also be sold to a party performing business at the premises. In a further advantageous embodiment of the invention, the content can include advertisements, which allows the service provider to finance the operation at least in part by selling advertisement space on the computer devices.

The computer devices may be laptop computers, notebook computers, tablet type computers, reading devices, or generally, any computer devices having a screen, and which preferably are easy to handle.

The content on the computer devices are preferably updated periodically. The invention is not limited to any specific period, and it may be different between update times and/or computer devices.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

Various embodiments of the invention will be described in detail below, by way of example only, with reference to the accompanying drawings, of which

FIG. 1 illustrates an advantageous embodiment of the invention,

FIG. 2 illustrates a method according to a first aspect of the invention, and

FIG. 3 illustrates a method performed by a server node according to a second aspect of the invention.

### DETAILED DESCRIPTION OF THE PREFERRED EMBODIMENTS

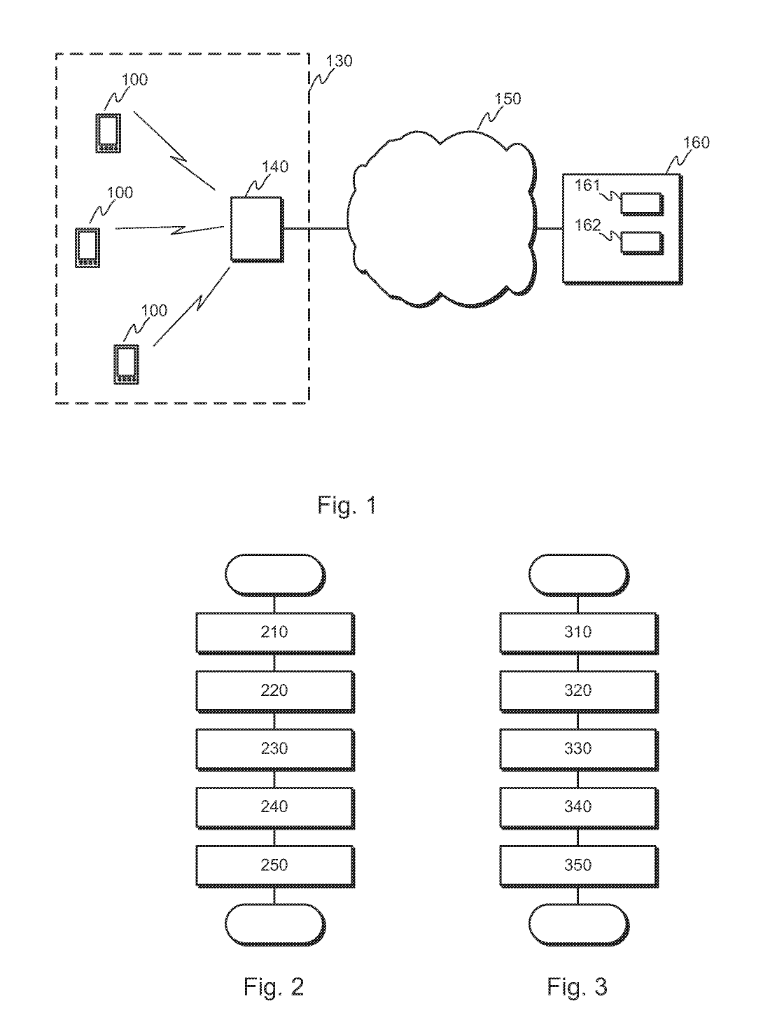

FIG. 1 illustrates an advantageous embodiment of the invention. FIG. 1 shows a plurality of computer devices 100, a wireless network base station 140, a data communication network 150, and a content server node 160. In this embodiment, the computer devices 100 are provided by the service provider to premises 130 of a business for use by patrons of the business.

The wireless network base station 140 can be for example a WLAN base station, or a wireless base station of any other wireless technology. In various embodiments of the invention, the base station does not need to be within the premises 130. For example if the computer devices 100 can connect to a cellular data communications network, the base station can be a base station of a cellular data communications network.

In this embodiment, the server node 160 is used to provide content updates to the computer devices 100. The service provider prepares updated content packages and places the packages on the server node 160. The process of provision of the updated content packages from the server node 160 to the computer devices 100 can be implemented in various ways. For example, the computer devices 100 can periodically poll the server 160 to check, whether there are new content packages to be installed, and download and install any new content packages. For another example, the server node 160 can create a connection to a computer device 100, check the installed content, and transmit a content package if a content package on the computer device 100 is of an older version or is missing.

In an advantageous embodiment of the invention, the server node 160 comprises a content database 161 for storing said content packages.

In a further advantageous embodiment of the invention, the server node 160 comprises an advertisement database 162 for storing advertisements to be provided to the computer devices 100.

In an advantageous embodiment of the invention, the role of the service provider is to provide a set of computer devices 100, which are ready-to-use with content already installed on the devices. The service provider can provide the devices for example on loan, or rent or lease the devices, or sell the devices to a business operating at the premises 130. The service provider further licenses content from content providers if any such content is desired which requires licensing. The service provider can also sell advertisement space on the computer devices.

In an advantageous embodiment of the invention, a computer device 100 has a user interface that limits the available programs the user can run and/or content that the user is able to view or interact with. This interface allows the service provider to tailor the user experience to the needs of the business, for which the computer devices are prepared.

The content provided in a computer device can be for example a map application, a service directory for local and non-local services, general news content, sports news content, tourist information concerning the geographical region of said premises, content describing coming events within the geographical region of said premises, games, films, advertisements, or for example a classified advertisements database.

Advantageously, at least one content item is installed on a computer device. In further advantageous embodiments of the invention, a content item can be represented by a link, which points to remote content located elsewhere in a data communications network such as the internet.

In a further advantageous embodiment of the invention, a charging device for charging a plurality of computer devices is provided. Advantageously, charging the device comprises a plurality of slots, which are dimensioned in such a way as to receive a computer device such as a tablet type computer.

Preferably, a charging connector is included in each slot, to allow charging of a computer device inserted in the slot.

Preferably, the slots are formed in such a shape that allows the computer devices to be inserted in one specific position only, so that a charging connector in the charging device mates properly with a corresponding connector in the computer device.

Preferably, the charging device further comprises a plurality of charging indicators. Such a charging indicator preferably indicates whether a computer device inserted into the charging device is being charged, or whether the computer device is fully charged. In an advantageous embodiment of the invention, the charging indicator comprises at least one light emitting diode. In an advantageous embodiment of the invention, the charging device comprises an electronic circuit, which observes the magnitude and/or waveform of charging current and/or voltage being supplied to a computer device, determines the charging state from the result of such observation, and drives the at least one light emitting diode of the charging indicator accordingly.

Advantageously, the charging device may also indicate whether a computer device is inserted properly in a slot. This indication can be determined for example on the basis of the observation of current flow through the charging connector in the slot.

Preferably, the charging device may also be used as a storage unit for the computer devices. In various embodiments of the invention, the charging device may hold a large number of computer devices, preferably at least 10 devices. However, the invention is not limited to any specific number of charging slots in a charging device.

Such a charging device is convenient for charging and storage of a plurality of computer devices. Charging large numbers of devices with conventional single-device plug-in chargers would be excessively cumbersome for the staff at the premises.

In a further advantageous embodiment of the invention, a device comprising charging functionality for a plurality of computer devices and a wireless network base station 140 is provided. The wireless network base station can for example be a WLAN (wireless local area network) base station. As a man skilled in the art, there are many different wireless communication technologies in use at the time of writing of this patent application, and the invention is not limited to the use of any specific wireless technology. Such a combined device has the advantage that the service provider can easily provide both the computer devices and a wireless network for the computer devices, both preconfigured so that the wireless network between the computer devices and the base station works without additional configuration of the computer devices at the premises, where the computer devices are provisioned. Further, the combined device can be connected to a data communications networks such as the internet in many different ways, for example via a wired connection to a data network at the installation premises, or via a wireless connection.

In a further advantageous embodiment of the invention, a computer device comprises an anti-theft feature. The anti-theft feature can be implemented in many different ways. For example, the computer device may comprise an RFID tag readable by RFID reading equipment at the exits of the premises, whereby the RFID reading equipment can be arranged to sound an alarm if a computer device carrying an RFID tag is carried past the RFID reading equipment. Similarly, the computer devices can comprise any other type of anti-theft tags. In a further advantageous embodiment of the invention, a computer device comprises software which monitors the location of the computer device for example through an integrated GPS receiver, or for example by monitoring signals from one or more base stations of a wireless network. If the software determines that the computer device moves outside the designated premises, the software can trigger an alarm. An alarm can be triggered in many different ways, such as by producing a sound through an internal loudspeaker in the computing device, or for example by sending a message to the wireless base station to which the computer device is connected, which message can cause an alarm signal at the base station or which message can be brought to the attention of staff at the premises and/or the service provider.

According to a first aspect of the invention illustrated in FIG. 2, a method for providing content at a premises is provided. In an advantageous embodiment according to this first aspect of the invention, the method comprises at least the steps of

preparing 210 content for a computer device,

installing 220 content in a plurality of computer devices,

transferring 230 said plurality of computer devices to an operator at said premises,

preparing 240 updated content for said leased computer devices, and

arranging 250 said updated content to be installed on said leased computer devices.

In a further advantageous embodiment of the invention according to this first aspect of the invention, the method further comprises at least the step of leasing said plurality of computer devices to said operator.

In a further advantageous embodiment of the invention according to this first aspect of the invention, the method further comprises at least the step of selling said plurality of computer devices to said operator.

In a further advantageous embodiment of the invention according to this first aspect of the invention, the method further comprises at least the step of licensing content from a content provider for inclusion in a plurality of computer devices.

In a further advantageous embodiment of the invention according to this first aspect of the invention, the method further comprises at least the step of buying content from a content provider for inclusion in a plurality of computer devices.

In a further advantageous embodiment of the invention according to this first aspect of the invention, the method further comprises at least the step of downloading content from a content provider.

In a further advantageous embodiment of the invention according to this first aspect of the invention, the method further comprises at least the step of downloading updated content from a content provider.

In a further advantageous embodiment of the invention according to this first aspect of the invention, the method further comprises at least the step of selling advertising space on said plurality of computer devices to an advertiser.

In a further advantageous embodiment of the invention according to this first aspect of the invention, the method further comprises at least the steps of

providing an advertisement database,

receiving location information from at least one of said plurality of computer devices,

searching advertisements from said database based on the received location information, and

transmitting advertisements retrieved from said database to said at least one of said plurality of computer devices.

In an advantageous embodiment of the invention, an advertisement shown on a computer device is selected from a plurality of advertisement at least in part on the basis of the location of the computer device.

The location of the computer device can be determined for example using a built-in location feature in the computer device, such as a GPS receiver. In a further advantageous embodiment of the invention, the location of the computer device can be determined on the basis of base station signals of a wireless communication network.

In a still further advantageous embodiment of the invention, the location information may be a predetermined parameter set in the computer device by the service provider. For example, if the service provider prepares a number of computer devices for use at a particular premises, the service provider can set a location information value corresponding to the location of the premises in these particular computer devices.

In a further advantageous embodiment of the invention, advertisements for display on a computer device are retrieved from an advertisement database on the basis of location information associated with the computer device.

In a further advantageous embodiment of the invention according to this first aspect of the invention, the method further comprises at least the step of installing an user interface on at least one of said computer devices, said user interface being arranged to allow user access to such content that is installed on said at least one of said computer devices in said step of installing or as a result of said step of arranging updated content to be installed.

In a further advantageous embodiment of the invention according to this first aspect of the invention, the method further comprises at least the step of installing an user interface on at least one of said computer devices, said user interface being arranged to deny access to at least one user interface function of an operating system of the computer device.

In a further advantageous embodiment of the invention according to this first aspect of the invention, the method further comprises at least the step of configuring a computer device to periodically send an update request to a server node.

In a further advantageous embodiment of the invention according to this first aspect of the invention, said step of arranging 250 further comprises the steps of

receiving a request from a computer device, and

transmitting said updated content to be installed to the requesting computer device.

In a further advantageous embodiment of the invention according to this first aspect of the invention, said step of arranging 250 further comprises the steps of

packaging said updated content, and

storing said updated content at a server node.

In a further advantageous embodiment of the invention according to this first aspect of the invention, said step of arranging 250 further comprises

creating a connection from said server node to a computer device, and

pushing a package of said updated content to the computer device.

In a further advantageous embodiment of the invention according to this first aspect of the invention, said step of arranging 250 further comprises the steps of

receiving a request from a computer device,

determining whether a request received from a computer device includes correct authentication credentials,

and if the received request included the correct authentication credentials,

transmitting said updated content to be installed to the requesting computer device.

According to a second aspect of the invention, a server node for providing content to a plurality of computer devices is provided. In an advantageous embodiment of the invention according to this second aspect of the invention, the server node is arranged to perform a a method illustrated in FIG. 3. According to this embodiment, the server node

is arranged to request 310 content from a content provider,

is arranged to receive 320 requested content from a content provider,

is arranged to prepare 330 received content for installation on a plurality of computer devices,

is arranged to receive 340 an update request from a computer device, and

is arranged to transmit 350 an updated content package as a response to a received update request.

In a further advantageous embodiment according to this second aspect of the invention, the server node is further arranged to receive at least one advertisement from an advertisement provider, and to prepare said at least one retrieved advertisement for installation on a plurality of computer devices.

In a further advantageous embodiment according to this second aspect of the invention, the server node is further

arranged to receive a plurality of advertisements from at least one advertisement provider,

arranged to store at least apart of received advertisements into a database,

arranged to receive location information from a computer device,

search said database at least in part based on location information received from the computer device, and

prepare advertisements retrieved from said database for installation on the computer device.

In view of the foregoing description it will be evident to a person skilled in the art that various modifications may be made within the scope of the invention.

While a preferred embodiment of the invention has been described in detail, it should be apparent that many modifications and variations thereto are possible, all of which fall within the true spirit and scope of the invention.

1. Method for providing content at a premises, comprising at least the steps of preparing content for a computer device, installing content in a plurality of computer devices, transferring said plurality of computer devices to an operator at said premises, preparing updated content for said leased computer devices, and arranging said updated content to be installed on said leased computer devices.

2. The method of claim 1, further comprising the step of leasing said plurality of computer devices to said operator.

3. The method of claim 1, further comprising the step of selling said plurality of computer devices to said operator.

4. The method of claim 1, further comprising at least the step of licensing content from a content provider for inclusion in a plurality of computer devices.

5. The method of claim 1, further comprising at least the step of buying content from a content provider for inclusion in a plurality of computer devices.

6. The method of claim 1, wherein said step of preparing content comprises at least the step of downloading content from a content provider.

7. The method of claim 1, wherein said step of preparing updated content comprises at least the step of downloading updated content from a content provider.

8. The method of claim 1, further comprising at least the step of selling advertising space on said plurality of computer devices to an advertiser.

10. The method of claim 1, further comprising at least the steps of providing an advertisement database, receiving location information from at least one of said plurality of computer devices, searching advertisements from said database based on the received location information, and transmitting advertisements retrieved from said database to said at least one of said plurality of computer devices.

11. The method of claim 1, wherein said computer device is a tablet computer.

12. The method of claim 1, further comprising at least the step of installing an user interface on at least one of said computer devices, said user interface being arranged to allow user access to such content that is installed on said at least one of said computer devices in said step of installing or as a result of said step of arranging updated content to be installed.

13. The method of claim 12, further comprising at least the step of installing an user interface on at least one of said computer devices, said user interface being arranged to deny access to at least one user interface function of an operating system of the computer device.

14. The method of claim 1, comprising further at least the step of configuring a computer device to periodically send an update request to a server node.

15. The method of claim 1, wherein said step of arranging further comprises the steps of
receiving a request from a computer device, and transmitting said updated content to be installed to the requesting computer device.

16. The method of claim 1, wherein said step of arranging further comprises the steps of packaging said updated content, and storing said updated content at a server node.

17. The method of claim 16, wherein said step of arranging further comprises creating a connection from said server node to a computer device, and pushing a package of said updated content to the computer device.

18. The method of claim 1, wherein said step of arranging further comprises the steps of receiving a request from a computer device, determining whether a request received from a computer device includes correct authentication credentials, and if the received request included the correct authentication credentials, transmitting said updated content to be installed to the requesting computer device.

19. A server node for providing content to a plurality of computer devices, wherein the server node is arranged to request content from a content provider, is arranged to receive requested content from a content provider, is arranged to prepare received content for installation on a plurality of computer devices, is arranged to receive an update request from a computer device, and is arranged to transmit an updated content package as a response to a received update request.

20. The server node according to claim 19, wherein the server node is further arranged to receive at least one advertisement from an advertisement provider, and to prepare said at least one retrieved advertisement for installation on a plurality of computer devices.

21. The server node according to claim 19, wherein the server node is further arranged to receive a plurality of advertisements from at least one advertisement provider, arranged to store at least apart of received advertisements into a database, arranged to receive location information from a computer device, search said database at least in part based on location information received from the computer device, and prepare advertisements retrieved from said database for installation on the computer device.
